(19) United States
(12) Patent Application Publication
(10) Pub. No.: US 2009/0132142 A1
(43) Pub. Date: May 21, 2009

(54) ADAPTIVE CRUISE CONTROL FOR HEAVY-DUTY VEHICLES

(75) Inventors: Michael P. Nowak, Menomonee Falls, WI (US); Sorin C. Bengea, St. Louis Park, MN (US); Peter B. Eyabi, Wixom, MI (US); Richard M. Avery, Battle Creek, MI (US); Robert O. Anderson, Kalamazoo, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: EATON CORPORATION, Cleveland, OH (US)

(21) Appl. No.: 11/574,950

(22) PCT Filed: Oct. 6, 2006
(86) PCT No.: PCT/IB2006/053679

§ 371 Date: Dec. 2, 2008

Related U.S. Application Data
(60) Provisional application No. 60/724,839, filed on Oct. 7, 2005.

(51) Int. Cl. B60T 8/32; B60K 31/00; G06F 17/00

(52) U.S. Cl. 701/93; 701/96

(57) ABSTRACT

An adaptive cruise control system and a method for controlling the speed of a vehicle are disclosed. The system generally includes a controller which determines a torque instruction associated with a limit speed of the vehicle which is less than a selected speed. The method generally includes determining a distance between the vehicle and an object detected in the path of the vehicles determining a torque instruction which is associated with a limit speed which is less than a selected speed from at least the distances and transmitting the torque instruction to an engine controller of the vehicle.

### CROSS-REFERENCE TO RELATED APPLICATIONS

This application claims priority to U.S. provisional application Ser. No. 60/724,839, filed Oct. 7, 2005, which is hereby fully incorporated by reference in its entirety.

### BACKGROUND

A vehicle cruise control system may adjust various vehicle systems with little driver intervention. The response characteristics of electronic controllers typically employed in cruise control systems are generally tuned for particular vehicle applications, taking into account a range of operating conditions such as vehicle weight and engine power. For example, when a controller detects that the vehicle speed has dropped below a desired cruising speed, the controller should respond quickly to increase the vehicle speed until it reaches the desired cruising speed, without causing the control system to “overshoot” the desired speed. While some overshoot of the desired speed is generally inherent and expected in a control system, overshoot should be minimized so that the cruise control operation is as transparent as possible to the operator.

Adaptive cruise control (ACC) systems, which may control a following distance between a vehicle and an object in a path of the vehicle, have become especially useful for heavy duty vehicles which are operated over long distances, such as semi-tractor trailers. However, heavy duty vehicles are particularly challenging applications for the design of cruise control systems, owing primarily to the widely disparate load conditions under which heavy-duty vehicles may be operated. For example, some tractor trailer configurations are designed to carry a maximum load in excess of 100,000 pounds, while weighing fewer than 20,000 pounds in an unloaded state. Due at least in part to the wide range of possible configurations, responses of current cruise control systems are often inappropriate across the wide range of loading conditions. For example, a cruise control system for a heavy duty vehicle will generally need to respond more quickly and with a greater degree of intervention, e.g., inputs to the engine of greater magnitude, when the vehicle is operating at maximum capacity as opposed to when it is unloaded.

Design compromises typically must be made to accommodate extremes such as the foregoing, e.g., resulting in a control system that may respond appropriately to a change in the road grade when a tractor-trailer is fully loaded, but that may also respond too quickly when it is unloaded, causing the system to overshoot a selected cruising speed. Conversely, a control system which responds appropriately to a change in road grade when a vehicle is in an unloaded configuration may not respond adequately when the vehicle is fully loaded, such that the vehicle may slow down significantly when going up a hill. Cruise control systems may therefore cause oscillations above and below a desired set speed for some time until the vehicle speed converges to the desired set speed. In sum, present cruise control systems do not respond accurately to changing driving conditions across the entire range of loading conditions with as short a time period for convergence as possible.

### BRIEF DESCRIPTION OF THE DRAWINGS

FIG. 1 illustrates an architecture of an adaptive cruise control system, according to an embodiment;

FIG. 2 illustrates an exemplary process for controlling the speed of a vehicle, according to an embodiment; and

FIG. 3 illustrates a control logic of a step of the exemplary process of FIG. 2.

### DETAILED DESCRIPTION OF THE PREFERRED EMBODIMENTS EXEMPLARY SYSTEM

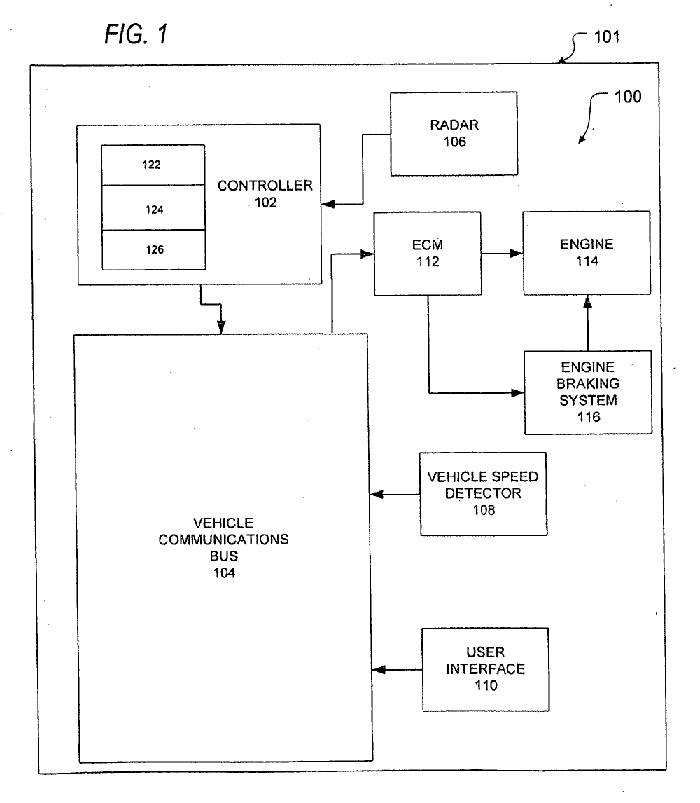

FIG. 1 provides a schematic representation of a cruise control system 100 for a vehicle 101, according to an embodiment. System 100 includes a speed controller 102 which may be in communication with various systems of vehicle 101 by way of a vehicle communications bus 104 to control a speed of vehicle 101. Controller 102 generally provides a torque instruction to an engine control module 112. For example, the torque instruction may include at least one of a torque command and a torque limit value. A torque command directs engine 114 to achieve a specified torque associated with a desired cruising speed. A torque limit value in embodiments disclosed herein preferably is given priority over the torque command. A torque limit command thereby generally slows a vehicle by limiting engine torque according to a torque instruction determined according to control logic implemented in controller 102 and transmitted via communications bus 104. Controller 102 may be provided on its own, or as a complementary feature of a conventional cruise control system.

Vehicle communications bus 104 generally provides a centralized communication platform for vehicle subsystems that are linked with vehicle communications bus 104. Such vehicle subsystems may provide commands and/or information in a standardized format to vehicle communications bus 104. Other vehicle subsystems linked to vehicle communications bus 104 may thereby receive or access the commands and/or information. Various types of known vehicle communications buses may be employed in vehicle 101. For example, vehicle communications bus 104 may operate according to the Society of Automotive Engineers J1939 standard, which is generally directed to communications systems for heavy duty vehicles.

Controller 102 may be directly linked with a radar device 106, which is operable to detect the presence of objects in the path of the vehicle 101. In one embodiment, an EVT-300 SmartCruise® system manufactured by Eaton Corporation, located in Cleveland, Ohio, is employed. Additionally, other devices that detect objects in the path of vehicle 101 may be used instead of or in addition to radar 106. For example, a camera or other light- or heat-sensitive system may be used in place of radar device 106. Further, radar device 106 need not be connected directly to controller 102. For example, radar device 106 may be conveniently linked with vehicle communications bus 104 to communicate with controller 102 over vehicle communications bus 104.

Controller 102 may also be in communication with a vehicle speed detector 108 over vehicle communications bus 104. Vehicle speed detector 108 generally provides a signal for indicating the speed of vehicle 101 to communications bus 104. Vehicle speed detector 108 may accomplish speed detection in a variety of ways. For example, vehicle speed detector 108 may measure the rotation of a wheel of vehicle 101, a gear of the vehicle transmission, an axle of the vehicle, etc. The foregoing indication of vehicle speed is typically provided for several other vehicle systems which rely on vehicle speed as a part of their operation. For example, a speedometer (not shown) typically is provided on vehicle 101 to indicate the vehicle speed to the operator, and generally receives an indication of the vehicle 101 speed via communications bus 104.

A user interface 110 may be provided for an operator of vehicle 101 to interact with and adjust operating parameters of system 100. User interface 110 may take a variety of forms, including, but not limited to, a control stalk mounted on the steering column, a keypad or buttons disposed on the steering wheel or dashboard, etc. User interface 110 typically allows a vehicle 101 operator to turn system 100 on and off and to set a cruising speed. Additionally, user interface 110 may allow the operator of vehicle 101 to increase or decrease the cruising speed of vehicle 101. Further, user interface 110 may allow the operator to adjust operating parameters of controller 102, such as, for example, a desired following distance between vehicle 101 and a lead vehicle. Controller 102 may include a heuristic for determining appropriate controller parameters from inputs selected by an operator of vehicle 101. Such a feature may be desirable to allow operators to adjust system 100 according to their own driving preferences. However, an adjustable parameter feature may be undesirable where fleet operators or manufacturers wish to provide a cruise control system with uniform operating characteristics, or to prevent drivers from altering settings preferred by the manufacturer.

An engine control module (ECM) 1112 generally governs and monitors operating parameters of an engine 114 in vehicle 101. ECM 112, as is known, may be connected with vehicle communications bus 104, and receive information from vehicle systems other than system 100 that may be useful for controlling the operation of engine 114. For example, ECM 112 may receive information and generally interact with a transmission control module (not shown) of vehicle 101, as is common in many vehicles.

System 100 further may include an engine retarder or engine braking system 116, such as is included in many heavy duty vehicles. Engine braking system 116 provides a secondary braking system for vehicle 101 which may be used in combination with the vehicle brakes (not shown) to slow vehicle 101. Secondary braking systems are useful for preventing excess wear of the vehicle braking system as a result of the harsh operating conditions typical of brake systems for heavy duty vehicles. Engine braking system 116 may alter the timing of the intake and exhaust valves of one or more cylinders of the engine to at least reduce the speed of the crankshaft, and even provide a force acting in opposition to the rotation of the crankshaft, slowing the crankshaft more significantly. Engine braking system 116 thereby slows the speed of engine 114, which in turn slows vehicle 101 through the transmission (not shown).

Controller 102 may be provided as a microprocessor and a memory, or as software otherwise provided or embedded within other processors or electronic systems of vehicle 101, such as, for example, ECM 112, or in any other known forms. Controller 102 in various embodiments may include instructions executable by one or more computing devices of vehicle 101. Such instructions may be compiled or interpreted from computer programs created using a variety of known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various types of conventional cruise control systems may be included or used in combination with controller 102. For example, in an embodiment, controller 102 includes a proportional-integral (PI) controller for maintaining a desired cruising speed of vehicle 101. A heuristic for developing a torque command to maintain a steady cruising speed may be provided in a number of forms, and may depend on the specific characteristics of the vehicle in which system 100 is implemented. Such characteristics may include the vehicle weight, engine size and/or power, transmission gear ratios, etc.

Controller 102 further generally includes three components for implementing ACC functions. The three components 122, 124, 126 may be segregated within hardware and/or software of controller 102, or may be integrated into a single hardware and/or software area of controller 102 that provides the three components. The first component, control logic 122, includes a supervisory control logic that may be used to determine an operating state of system 100. The second component, torque instruction component 124, includes a heuristic for determining a torque instruction according to various inputs to controller 102 and the operating state of the ACC portion determined in first component 122. The third component, torque instruction formatting component 126, converts the torque instruction determined in torque instruction component 124 into a message compatible with vehicle communications bus 104. In one embodiment, the message is formatted and provided over communications bus 104 according to the J1939 standard. The operation of the three components is further described below in regard to an exemplary process.

### Exemplary Process

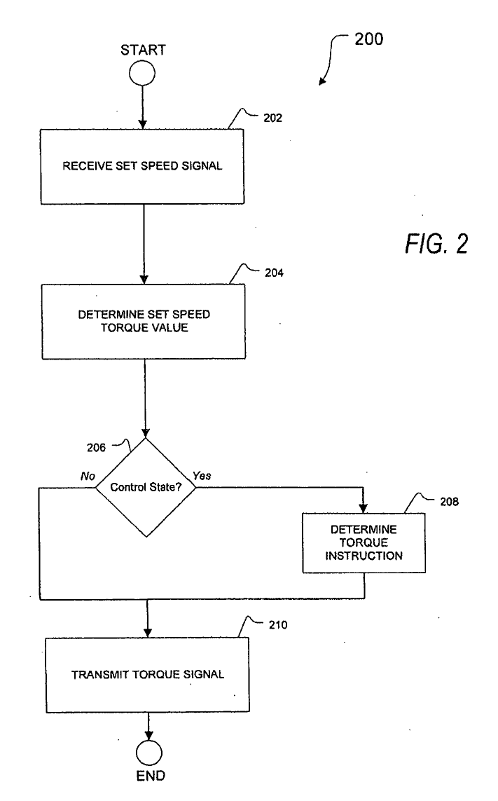

Turning now to FIG. 2, an exemplary process 200 that may be tangibly embodied in controller 102 is illustrated. In step 202, which is optional and is omitted in certain embodiments described below, a set speed signal is received by controller 102. A set speed signal may be provided when an operator accesses controller 102 via user interface 110. The set speed signal then indicates a desired cruising speed as set by an operator of vehicle 101. Process 200 may proceed to step 204.

Next, at step 204, which is optional and may be replaced by other steps as described below, an engine torque may be determined that is associated with the set speed selected in step 202. As described above, controller 102 may include a heuristic to determine an engine torque to maintain a desired set speed. A variety of known control heuristics may be implemented, and may take into account vehicle characteristics such as the vehicle mass, engine configuration and/or available power, etc. Such heuristics may be embodied within controller 102, or other vehicle subsystems such as, for example, ECM 112. A torque value, or any other control parameter determined in step 204, may be stored within a memory of controller 102 it is recalled in step 210.

In some embodiments step 202 is omitted and step 204 is replaced with another step for specifying a desired cruising speed using controller 102. For example, step 204 may additionally include determining any non-torque parameter associated with a desired set speed, e.g., engine speed, transmission speed, engine power, etc.

Next, in step 206, control logic component 122 determines whether a control state exists in controller 102, and therefore controller 102 should supply a torque instruction to ECM 112. This determination is generally made according to an operating state in controller 102 that may generally be either a “control” state or a “no control” state. A first operating state of controller 102 may be referred to as a “no control” state. This may be the case where, for example, no object is detected in front of vehicle 101 by radar device 106, or controller 102 has not been activated by an operator of vehicle 101. Controller 102 may also be in this state if a lead object has been identified by radar device 106 that is determined by controller 102 not to be a collision hazard, e.g., an object traveling faster than vehicle 101. To determine whether the no-control state applies, the distance between vehicle 101 and any object in front of vehicle 101 (i.e., range) and the relative velocity between vehicle 101 and the object may be low-pass filtered versions of actual measurements of radar device 106, to prevent signal noise from triggering intervention of ACC subsystem 120. Controller 102 may determine from a current speed of vehicle 101, and other vehicle and road parameters, whether it is necessary for controller 102 to initiate a control state.

Control logic 122 of controller 102 may determine that a control state exists at step 206 in response to a number of factors. For example, if controller 102 determines that a following distance between vehicle 101 and an object sensed by radar device is more or less than that desired, controller 102 may initiate a control state. Controller 102 may also rely on parameters such as indications of non-ideal road conditions, such as, for example, vehicle 101 is traveling on a gravel road, or there is rain or snow on the road, to determine whether a control state exists. Such non-ideal road conditions may be detected by controller 102 with a variety of known equipment for sensing moisture, vibration, etc.

Another example where controller 102 may determine that a control state exists may be referred to as a “resuming cruise speed” state. In this state, controller 120 transmits a series of torque instructions, but is increasing a torque value associated with these torque instructions over time to raise the speed of vehicle 101 back to a selected cruising speed. This “resuming cruise speed” state may occur when system 100 has lost a lead object (e.g., vehicle 101 or a lead vehicle has turned or otherwise left the path of the other) and is transitioning back to a desired set speed. For this operating state, the resume speed may be a calculated speed that slowly ramps up to the desired set speed.

Where ACC system 120 is in a “no-control” state, process 200 proceeds from step 206 to step 210. However, if ACC system 120 is in either a “distance control” state or a “resuming CCC speed” state, process 200 proceeds to step 208.

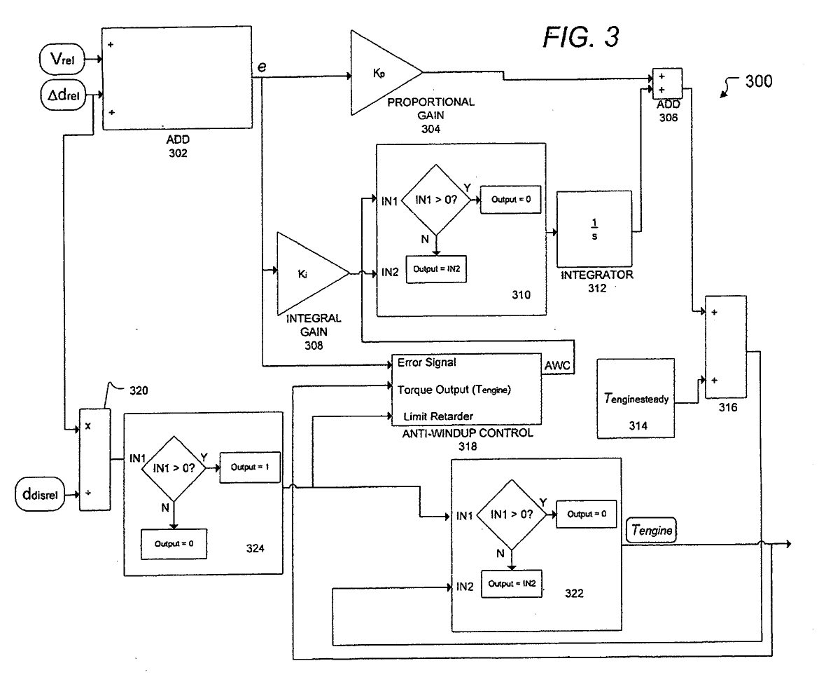

In step 208, torque instruction component 124 of ACC subsystem 120 determines a torque instruction. The torque instruction may include a torque command instructing engine 114 to attain a specified torque, or a torque limit value instructing engine braking system 116 to reduce a torque output of engine 114. As described above, controller 102 may receive an input from radar device 106 indicating a distance between vehicle 101 and an object in the path of vehicle 101, and also a rate at which the distance is changing (i.e., relative velocity). Controller 102 may also receive a signal indicating a current speed of vehicle 101 from vehicle speed detector 108. Controller 102 may generally determine a torque instruction from a heuristic that includes a distance and/or relative velocity between vehicle 101 and a detected object in the path of vehicle 100. Aspects of an exemplary control heuristic for determining a torque instruction are illustrated in FIG. 3, discussed below.

Step 208 may include a PI control logic. However, the control logic used by controller 102 to determine a torque instruction may take other forms. For example, an embodiment includes a non-linear control logic, wherein a torque instruction is determined within the known Lyapunov framework. A PI-based controller may be slightly less sensitive to noise and low resolution of the radar measurements received from radar device 106, and therefore is generally preferable over a non-linear control logic.

FIG. 3 illustrates an exemplary PI control model that may be used in determining a torque instruction. A PI control model representing step 208 is illustrated in FIG. 3, as an example. The PI control model generally includes at least an input add block 302, proportional gain block 304, integral gain block 308, integration block 312, add block 306, steady-state torque input block 314, and output add block 316. Steps 310, 318, 320, 322, and 324 are optional, as described below.

A general objective of the control logic illustrated in FIG. 3 is to maintain a specified desired distance d_{disrel} between vehicle 101 and any object detected in front of vehicle 101. A desired distance between vehicle 101 and a detected object, d_{disrel}, may be found by multiplying the current speed of vehicle 101 as indicated by speed detector 108 by a desired time headway between the vehicle 101 and a detected object in the path of vehicle 101:

d_{disrel}=v_{vehicle}*h (1)
where: v_{vehicle}=velocity of vehicle 101
h=desired time headway The desired time headway h may be determined according to specific characteristics of vehicle 101, such as, for example, a mass of the vehicle, stopping performance, handling characteristics, or any other factors which may affect collision risks of vehicle 101. Further, the desired time headway h may be adjusted by an operator of vehicle 101 through user interface 110.

In addition to radar measurements received by controller 102, vehicle and road parameters may be used to generate a torque instruction. The torque instruction generally includes two components: a steady-state component, T_{enginesteady}, associated with a current speed, and a transient-error-dependent component, ΔT_{engine}:

T_{engine}=T_{enginesteady}+ΔT_{engine} (2)

The steady-state torque, T_{enginesteady}, is the torque required to maintain constant speed after radar device 106 acquires a target lead object. This torque component is a function of the vehicle speed, vehicle parameters (e.g., transmission gear ratio, component inertia, component efficiency, wheel radius, vehicle aerodynamics, etc.) and road parameters (e.g., road grade, friction coefficient, etc.). In determining the second component, ΔT_{engine}, two sets of factors may generally be considered: (1) compensation for inaccuracies in the estimated vehicle and road parameters; and (2) generation of the appropriate torque instruction required for control of the distance between vehicle 101 and an object detected in the path of vehicle 101.

The component ΔT_{engine} operates during the transient response of controller 102, when vehicle 101 speed and distance from a detected object do not have desired steady-state values (i.e., radar device 106 acquires a target lead vehicle and a following distance is greater or less than desired). This torque value ΔT_{engine} compensates for the difference between the desired values and actual values, or errors, related to both relative velocity and distance defined as follows:

vᵣₑₗ=v_{lead}−vₕₒₛₜ (3)

dᵣₑₗ=d_{lead}−dₕₒₛₜ (4)

As shown in FIG. 3, vᵣₑₗ is an input of add block 302. The second input of add block 302 is Δdᵣₑₗ, which is defined as Δdᵣₑₗ=dᵣₑₗ−d_{disrel} (with d_{disrel} given by equation (1)). The overall error of the system, e, is the output of add block 302:

e=vᵣₑₗ+C_{d}*Δdᵣₑₗ (5)

where C_{d} is a weighting coefficient between the velocity and distance control objectives, respectively. The overall error e is output from add block 302, and is input to proportional gain step 304. The overall error e is also input to integral gain block 308. The output of integral gain block 308 may be directly input to integrator 312. Optionally, the output of integral gain block is input to switch block 310, as described below. The output of integrator 312 is input to add block 306, along with the output of proportional gain block 304. The output of add block 306 is therefore the transient error component, ΔT_{engine}:

ΔT_{engine}=K_{P}*e+K_{I}*∫e (6)

ΔT_{engine} is therefore in the general form of a classical PI controller, and minimizes the overall system error because it implicitly compensates for model inaccuracies.

The torque instruction, T_{engine}, is generally the sum of the steady-state component, T_{enginesteady} and ΔT_{engine}. T_{enginesteady} may be determined by controller 102 according to various vehicle parameters as is known, and input with input block 314. Combining equations (2), (5), and (6) yields an output torque instruction at block 316, T_{engine}:

T_{engine}=T_{engine,steady}+K_{P}*(vᵣₑₗ+C_{d}*Δdᵣₑₗ)+K_{I}*∫(vᵣₑₗ+C_{d}*Δdᵣₑₗ) (7)

As opposed to a torque instruction including only a PI controller component, equation (7) advantageously has smaller controller gains, even when the engine, vehicle, or road parameters are not precisely known. The control logic of ACC subsystem 120 therefore adapts quickly to demands for rapid change in vehicle 101 speed, while not being overly aggressive during steady-state vehicle following situations.

The dynamic performance related to settling time, overshoot, and damping of an ACC heuristic depends on controller parameters such as C_{d}, and controller gains Kₚ and Kᵢ. Some constraints on these parameters can be determined as a result of the expected performance in certain driving scenarios. For example, in some scenarios (such as lead vehicle cut-in scenarios where the lead vehicle velocity is greater than vehicle 101), it is desirable that ACC subsystem 120 not affect the speed of vehicle 101. Assuming that vehicle 101 speed was constant previous to these scenarios, the requirement may be that controller 102 maintains the current speed of vehicle 101. Assuming knowledge of the vehicle parameters, this implies that ΔT must be equal to zero. Therefore, by utilization of the values of vᵣₑₗ and dᵣₑₗ one can impose a constraint on the controller gains.

Accordingly, T_{engine} represents a torque instruction which may include a torque command or a torque limit value. T_{engine} may be the output from add block 316. Alternatively, optional components 310, 318, 320, 322, and 324 may be included to improve various aspects of controller 102 performance.

Anti-windup control 318 is optional, and may be used in conjunction with switch block 310 to reduce output of integrator 312 in cases where the torque instruction commands a torque that is outside maximum or minimum limits capable of being provided by engine 114 and engine braking system 116, respectively. The inputs of anti-windup control block 318 are the torque instruction, T_{engine}, and the error signal determined in add block 302, as described above. Anti-windup control block 318 may determine an anti-windup control (AWC) signal, from any known heuristic identifying cases where the input to integrator 312 is preferably limited. As an example, it may be desirable to limit integrator 312 when T_{engine} is beyond a maximum torque available from engine 114. Additionally, the heuristic of anti-windup control block 318 may be adjustable by an operator of vehicle 101. The output AWC signal is therefore the integer one when it is desirable to limit input to integrator 312, and zero when it is desirable to allow the output of integral gain block 308 to be input to integrator 312.

Switch 310 receives as inputs the AWC signal determined by anti-windup control block 318, and the output of integral gain block 308. In cases where the AWC signal output from anti-windup control block 318 is less than or equal to zero, switch block 310 transmits the output of integral gain block 308 to integrator 312. Where the AWC signal is greater than zero, switch block 310 transmits a value of zero to integrator 312, thus minimizing output of integrator block 312.

An optional limiting function may be applied by division block 320 and switch block 324 to deactivate engine braking system 116 when it is not needed. Δdᵣₑₗ and d_{disrel} are input to division block 320, which divides Δdᵣₑₗ by d_{disrel}. This output is input to switch 324. Where Δdᵣₑₗ is less than zero, such that the output of division block 320 is negative, the output of switch 324 is the integer one. Where the output of division block 320 is greater than zero, the output of switch block 324 is zero. Additionally, other thresholds besides the integer zero may be employed to determine whether the output of switch block 324 should be one or zero. The output of switch block 324 may be input to anti-windup control 318, which may deactivate engine braking system 118 where the output of switch 324 is zero. Accordingly, engine braking system 116 will be disabled when the actual headway is greater than the desired headway, h, since engine braking system 116 is generally not needed in these situations.

Additionally, at switch block 322, which is optional, the output T_{engine} may be minimized when the limit retarder signal is the integer one. The inputs to switch block 322 are the limit retarder signal from switch block 324, and the output of add block 316. Where the limit retarder signal is one, engine braking system 116 is deactivated and, accordingly, switch block 322 sets T_{engine} to zero. Alternatively, where the limit retarder signal is zero, switch block 322 may transmit T_{engine} as the torque instruction for engine 114.

Returning to FIG. 2, once a torque instruction is determined in step 208, the torque instruction may be stored in a memory or otherwise captured by controller 102 for retrieval in step 210, which follows step 208.

In step 210, torque instruction formatting component 126 of controller 102 may transmit a torque instruction, to vehicle communications bus 104. The output torque instruction may include at least one of a torque command and a torque limit value, as determined in step 208. Step 210 includes formatting the torque instruction for compatibility with vehicle communications bus 104. In one embodiment, where vehicle communications bus 104 operates in accordance with the SAE J1939 standard, torque instruction formatting component 126 formats the torque instruction in accordance with the J1939 standard. The torque instruction is transmitted over communications bus 104 to ECM 112 after any formatting is applied. ECM 112 may alter the operating parameters of engine 114 and/or engine braking system 116 to implement the desired torque instruction, wherein the torque limit command of step 208, if present, takes priority over any set speed torque signal, such as that determined in step 204, or any other set speed signal. Controller 102 may thereby decrease the torque output of engine 114 to reduce a speed of vehicle 101 below a desired set speed. An engine torque limit value is generally transmitted when in the distance control state or the resuming CCC speed state. Additionally, for certain situations (e.g., close vehicle cut-in scenarios), controller 102 will generate negative torque limit values that are interpreted by controller 102 in step 210 to indicate application of engine braking system 116. If the desired torque is such that engine braking system 116 is currently being applied, an engine torque limit command may be sent with a desired torque of zero to apply a maximum effect of engine braking system 116.

### CONCLUSION

Controller 102 may therefore command a desired torque at engine 114 with a torque instruction that may include a torque command or a torque limit value, allowing for seamless switching between positive engine torque and negative engine torque commands implemented by engine braking system 116. A negative desired torque may be interpreted as commands to activate engine braking system 116, while a positive desired torque may be realized through engine torque limit commands that are steadily increased over time to allow the engine torque to increase back to a cruising speed. Controller 102 may thereby quickly adapt to aggressive traffic scenarios, such as where a vehicle cuts in front of vehicle 101, while also not being overly aggressive during steady-state vehicle following situations resulting in smooth control performance. Further, performance of controller 102 is generally robust despite imprecise knowledge of the vehicle and road parameters, such that system 100 may provide adequate response across a wide range of operating conditions.

Reference in the specification to “one embodiment” or “an embodiment” means that a particular feature, structure, or characteristic described in connection with the embodiment is included in at least one embodiment. The phrase “in one embodiment” in various places in the specification does not necessarily refer to the same embodiment each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A speed controller, comprising:
a supervisory control logic component configured to determine an operating state of the speed controller;
a torque instruction component configured to determine a torque instruction based upon inputs to the speed controller and the operating state; and
a messaging component configured to include the torque instruction in a message, the message further including an input to an engine braking system of the vehicle.

2. The speed controller of claim 1, wherein the torque instruction includes at least one of a torque command and a torque limit value.

3. The speed controller of claim 1, wherein the operating state is one of a no control state and a control state.

4. A speed controller, comprising:
a supervisory control logic component configured to determine an operating state of the speed controller;
a torque instruction component configured to determine a torque limit value based upon inputs to the speed controller and the operating state; and
a messaging component configured to include the torque limit value in a message.

5. The speed controller of claim 4, wherein the operating state is one of a no control state and a control state.

6. The speed controller of claim 4, wherein the message further includes an input to an engine braking system of the vehicle.

7. A method of controlling the speed of a heavy duty vehicle, comprising:
determining a control state of a speed controller;
determining a torque limit value from at least the control state; and
transmitting the torque limit value to an engine controller of the vehicle.

8. The method of claim 7, further comprising reducing a torque output of an engine of the vehicle with an engine braking system.

9. The method of claim 7, wherein determining the control state includes determining a distance between the vehicle and an object in a path of the vehicle.

10. The method of claim 9, further comprising determining the distance with a radar device.

11. The method of claim 7, further comprising determining a speed of the vehicle;
wherein the torque limit value is determined from at least the speed of the vehicle.

12. The method of claim 7, further comprising receiving a set speed signal;
wherein the set speed signal is associated with a speed approximately equal to a cruising speed of the vehicle.

13. The method of claim 7, further comprising receiving at least one variable parameter for the speed controller.

14. The method of claim 7, further comprising determining a relative speed between the vehicle and an object in a path of the vehicle;
wherein the torque limit value is determined from at least the relative speed between the vehicle and the object.

15. The method of claim 7, wherein transmitting the torque limit value to the engine controller includes providing the torque limit value over a J1939 vehicle communications bus.

16. A computer-readable medium containing processor-executable instructions, the instructions configured to cause a processor to perform the method of claim 7.

17. A method of controlling the speed of a heavy duty vehicle, comprising:
determining a control state of a speed controller;
determining a torque instruction from at least the control state;
transmitting the torque instruction to an engine controller of the vehicle; and
reducing a torque output of an engine of the vehicle with an engine braking system.

18. The method of claim 17, wherein the torque instruction includes at least one of a torque command and a torque limit value.

19. The method of claim 17, wherein determining the control state includes determining a distance between the vehicle and an object in a path of the vehicle.

20. The method of claim 19, further comprising determining the distance with a radar device.

21. The method of claim 17, further comprising receiving a set speed signal;
wherein the set speed signal is associated with a speed approximately equal to a cruising speed of the vehicle.

22. The method of claim 17, further comprising receiving at least one variable parameter for the speed controller.

23. The method of claim 17, further comprising determining a speed of the vehicle;
wherein the torque instruction is determined from at least the speed of the vehicle.

24. The method of claim 17, further comprising determining a relative speed between the vehicle and an object in a path of the vehicle;
wherein the torque instruction is determined from at least the relative speed between the vehicle and the object.

25. The method of claim 17, wherein transmitting the torque instruction to the engine controller includes providing the torque instruction over a J1939 vehicle communications bus.

26. A computer-readable medium containing processor-executable instructions, the instructions configured to cause a processor to perform the method of claim 17.
